(19) United States
(12) Patent Application Publication
(10) Pub. No.: US 2015/0256207 A1
(43) Pub. Date: Sep. 10, 2015

(54) MULTI-BAND RECEIVER AND SIGNAL PROCESSING METHOD THEREOF

(71) Applicant: Telefonaktiebolaget L M Ericsson (publ), Stockholm (SE)

(72) Inventors: Jichang Liao, Beijing (CN); Jiangyan Peng, Beijing (CN); Yong Wang, Beijing (CN)

(21) Appl. No.: 14/430,609

(22) PCT Filed: Sep. 26, 2012
(86) PCT No.: PCT/CN2012/081975

§ 371 Date: Mar. 24, 2015

(51) Int. Cl. H04B 1/00; H04B 1/10; H04B 1/18

(52) U.S. Cl. CPC H04B 1/0064; H04B 1/18; H04B 1/1081

(57) ABSTRACT

Present invention provides a multi-band receiver for receiving and processing different frequency band signals, which comprises: a direct sampling module, for receiving and processing a low frequency band input signal from a first antenna; at least one single down conversion module, for receiving and processing a high frequency band input signal from a second antenna; a combiner coupled to the direct sampling module and the at least one single down conversion module, for combining the low frequency band input signal received from the direct sampling module and the high frequency band input signal received from the at least one single down conversion module; an Analog Digital Converter (ADC) coupled to the combiner, for converting analog signal received from the combiner into digital signal.

### TECHNICAL FILED

The embodiments of present invention generally relate to the wireless communication devices, particularly to the multi-band receiver for receiving and processing different frequency band signals in wireless communication system.

### DESCRIPTION OF THE PRIOR ART

Wireless communication system continues develop at a rapid pace, and the increasing number of systems and frequency bands in use are conflicting with the customer demand for increased mobility. However, almost all known wireless communication devices are single band type, since it is difficult to incorporate multi-band capabilities into wireless communication device, with given size and cost limitation.

However, still there is an increasing need for a dual band (or multi-band) receiver which receives simultaneously at least two or more different frequency band signals, via a single receiver. To meet such a need, there are several multi-band receiving solutions proposed in the prior art. FIG. 1 depicts one example of dual-band receiving solutions according to the prior art. As illustrated in FIG. 1, the different frequency band signals received from antenna will be sent to the two parallel paths. Each of the path including Band Pass Filter (BPF) 101, Low Noise Amplifier 102, BPF 103, Mixer 104 and BPF 105. The signals processed by the two paths will be combined by combiner 106, amplified by Intermediate Frequency (IF) amplifier 107, and processed by IF Variable Gain Amplifier (VGA) 108, BPF 109, and sent to Analog Digital Converter (ADC) so that the analog signal is converted to the digital signal.

As it can be understood by the proposed solution in the prior art, it cannot support the multiple frequency band signals with wide frequency difference. Also, in case that the bandwidth of the radio frequency signal is relatively large, the requirement to the mixer in the receiver is very high and also it is hard to do the frequency plan. Therefore, the traditional multi-band receiving solution cannot be understood as the real multi-band receiving solution, and the application scenario is also limited.

### SUMMARY OF THE INVENTION

To solve at least one of the above mentioned problems in the art, the embodiments of present invention provide a multi-band receiver for receiving and processing different frequency band signals, and processing method thereof.

According to one aspect of present invention, an embodiment of present invention provides a multi-band receiver for receiving and processing different frequency band signals, comprising: a direct sampling module, for receiving and processing a low frequency band input signal from a first antenna; at least one single down conversion module, for receiving and processing a high frequency band input signal from a second antenna; a combiner coupled to the direct sampling module and the at least one single down conversion module, for combining the low frequency band input signal received from the direct sampling module and the high frequency band input signal received from the at least one single down conversion module; an Analog Digital Converter (ADC) coupled to the combiner, for converting analog signal received from the combiner into digital signal.

According to another aspect of present invention, an embodiment of present invention comprises: A method for receiving and processing different frequency band signals, comprising: receiving and processing low frequency band input signal by direct sampling module; receiving and processing high frequency band input signal by at least one down conversion module; combining the low frequency band input signal received from said direct sampling module and the high frequency band input signal received from said at least one down conversion module by combiner; converting analog signal received from the combiner into digital signal by an Analog Digital Converter (ADC).

According to one or more embodiments of present invention, the multi-band receiver can be easily implemented and can cover relatively wide frequency band input signal. In addition, it can significantly reduce the cost, and reduce the size of the wireless communication receiver.

### BRIEF DESCRIPTION OF DRAWINGS

The features and advantages of the present invention will be more apparent from the following exemplary embodiments of the invention illustrated with reference to the accompanied drawings, in which:

FIG. 1 illustrates one example of the dual band receiver according to the prior art.

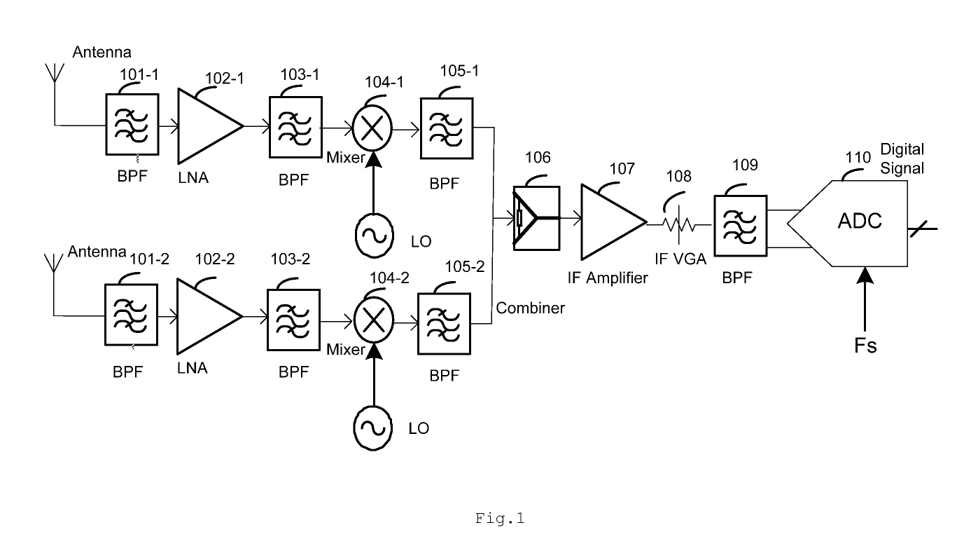

FIG. 2 illustrates a general structure diagram of a multi-band receiver according to an exemplary embodiment of present invention.

FIG. 3 illustrates a schematic structural diagram of an multi-band receiver according to an exemplary embodiment of present invention.

FIG. 4 illustrates a flowchart showing a method for receiving and processing different frequency band signals according to an exemplary embodiment of present invention.

FIG. 5 illustrates a flowchart showing a processing method performed by a direct sampling module according to an exemplary embodiment of present invention.

FIG. 6 illustrates a flowchart showing a processing method performed by at least one down conversion module according to an exemplary embodiment of present invention.

FIG. 7 illustrates signal characteristic analysis of multi-band receiver according to an exemplary embodiment of present invention.

### DETAILED DESCRIPTION

Hereafter, embodiments of present invention will be described with reference to the accompanying drawings. In the following description, many specific details are illustrated so as to understand the present invention more comprehensively. However, it is apparent to the skilled in the art that implementation of the present invention may not have these details. Additionally, it should be understood that the present invention is not limited to the particular embodiments as introduced here. On the contrary, any arbitrary combination of the following features and elements may be considered to implement and practice the present invention, regardless of whether they involve different embodiments. Thus, the following aspects, features, embodiments and advantages are only for illustrative purposes, and should not be understood as elements or limitation of the appended claims, unless otherwise explicitly specified in the claims. Throughout the drawings, the same reference numerals are used to refer to the same or similar elements.

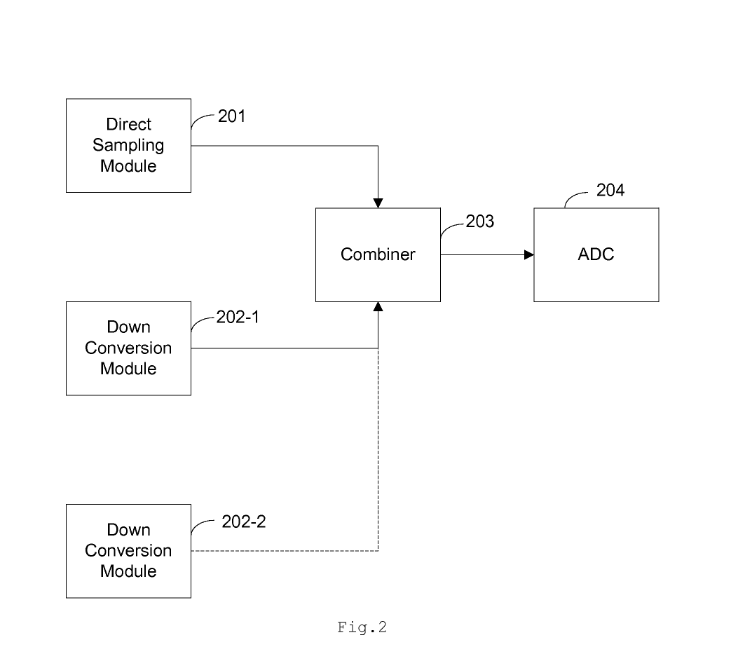

FIG. 2 illustrates a general structure diagram of a multi-band receiver according to an exemplary embodiment of present invention. As illustrated in FIG. 2, the multi-band receiver for receiving and processing different frequency band signals comprises a direct sampling module 201, at least one down conversion module 202, combiner 203 and Analog Digital Converter (ADC) 204.

The direct sampling module 201 receives and processes low frequency band input signal. At least one down conversion module 202 receives and processes high frequency band input signal. For example, if there are two high frequency band input signals are input from antenna, two down conversion modules (202-1, 202-2) might be needed, i.e., the number of the down conversion modules are the same as the number of the high frequency band signals input from antenna.

Here, low frequency band input signal denotes the signal can be directly sampled without the down conversion. Optionally, the low frequency band input signal can be the signal with frequency band below or equal to 1 GHz. The high frequency band input signal denotes the signal cannot be directly sampled and should be down converted. Optionally, the high frequency band input signal can be the signal with frequency band above 1 GHz. The combiner 203 combines the low frequency band input signal received from the direct sampling module 201 and high frequency band input signal received from the at least one down conversion module 202 (202-1, 202-2). ADC 204 converts analog signal received from the combiner 203 into digital signal.

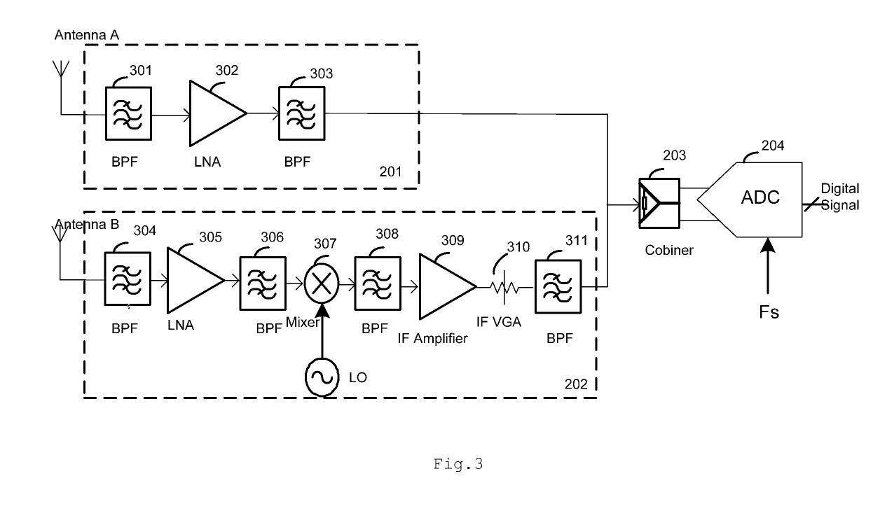

FIG. 3 illustrates a schematic structural diagram of a multi-band receiver according to an exemplary embodiment of present invention. As illustrated in FIG. 3, according to an exemplary embodiment of present invention, the direct sampling module 201 comprises a first Band Pass Filter (BPF) 301, a first Low Noise Amplifier (LNA) 302, and a second BPF 303. The first BPF 301 filters the low frequency band input signal received from antenna A. The first LNA 302 coupled to the first BPF 301, amplifies the low frequency band input signal received from the first BPF 301. The second BPF 303 coupled to the first LNA 301, filters the low band frequency input signal received from the first LNA 302, so as to avoid alias and avoid impacting the high band input signal received from the at least one single down conversion module.

Again refer to FIG. 3, according to an exemplary embodiment of the present invention, the at least one down conversion module comprises a third BPF 304, a second LNA 305, a fourth BPF 306, a mixer 307, a fifth BPF 308, an amplifier 309, a Variable Gain Amplifier (VGA) 310, and a sixth BPF 311. The third BPF 304 filters the high band frequency input signal received from antenna B. The second LNA 305 coupled to the third BPF, amplifies the high frequency band input signal received from the third BPF 304. Optionally, the third BPF 304 and first BPF 301 can be the same and one BPF shared by the direct sampling module 201 and the at least one down conversion module 202. Further, optionally the second LNA 305 and the first LNA 302 can be the same and one LNA shared by the direct sampling module 201 and the at least one down conversion module 202.

The fourth BPF 306 coupled to the second LNA 305, filters the high frequency band input signal received from the second LNA 305. The mixer 307 coupled to the fourth BPF 306, mixes the high frequency band input signal received from the fourth BPF 306 with the signal from a local oscillator (LO), so as to produce intermediate frequency (IF) signal. The fifth BPF 308 coupled to the mixer 307, filters the IF signal received from the mixer 307. Optionally, the fourth BPF 306 or the fifth BPF 308 can be the Surface Acoustic Wave (SAW) filter. The amplifier 309 coupled to the fifth BPF 308, amplifies the IF signal received from the fifth BPF 308. The variable gain amplifier (VGA) 310 coupled to the amplifier 309, compensates the gain of the IF signal received from the amplifier 309. The sixth BPF 311 coupled to the VGA 310, filters the IF signal received from the VGA 310, so as to avoid alias and avoid impacting the low frequency band input signal received from the direct sampling module 201. Optionally, the antenna A and antenna B can be the same and one antenna for receiving both the low frequency band input signal and high frequency band input signal.

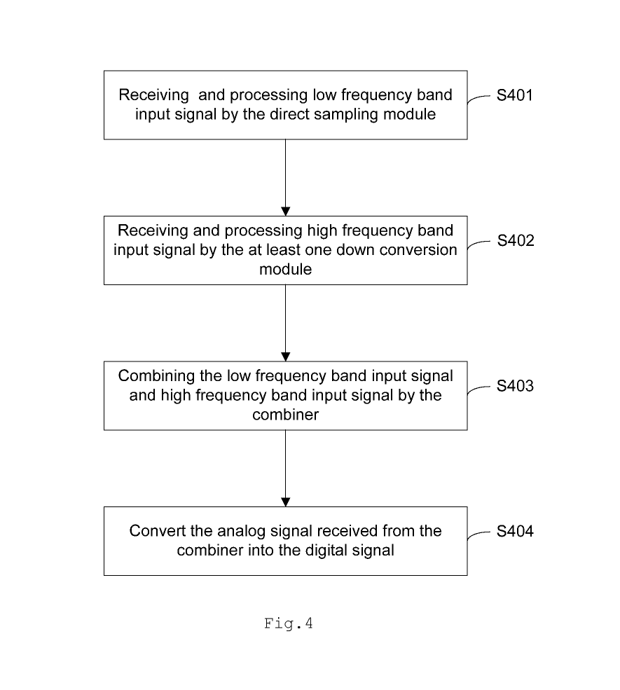

FIG. 4 illustrates a flowchart showing a method for receiving and processing different frequency band signals according to an exemplary embodiment of present invention. As illustrated in FIG. 4, in step S401, the low frequency band input signal is received and processed by the direct sampling module 201. In parallel, in step S402, the high frequency band input signal is received and processed by the at least one down conversion module 202. In step S403, the low frequency band input signal received from the direct sampling module 201 and the high frequency band input signal received from the at least one down conversion module 202 is combined by the combiner 203. Further in step S404, the analog signal received from the combiner is converted into the digital signal for further processing.

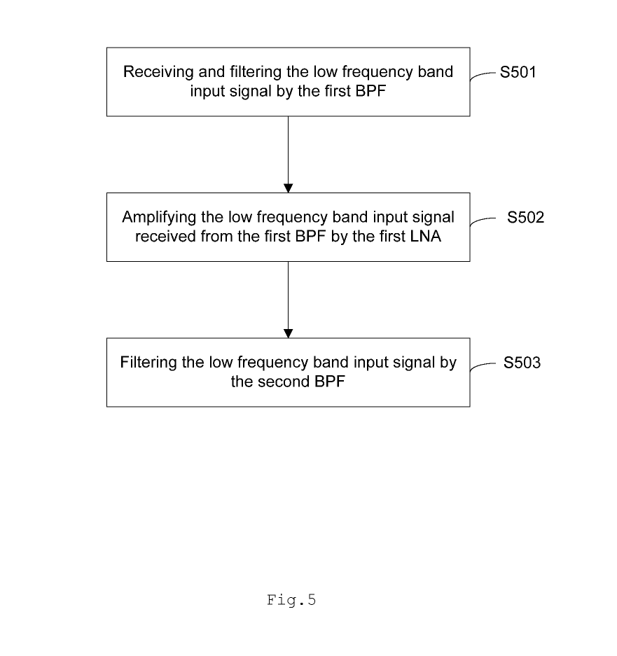

FIG. 5 illustrates a flowchart showing a processing method performed by a direct sampling module according to an exemplary embodiment of present invention. As illustrated in FIG. 5, in step S501, the low frequency band input signal is received and filtered by the first BPF 301. In step S502, the low frequency band input signal received from the first BPF 301 is amplified by the first LNA 302. Further in step S503, the low band frequency input signal received from the first LAN 302 is filtered by the second BPF 303, so as to avoid alias and avoid impacting the high band input signal received from the at least one single down conversion module.

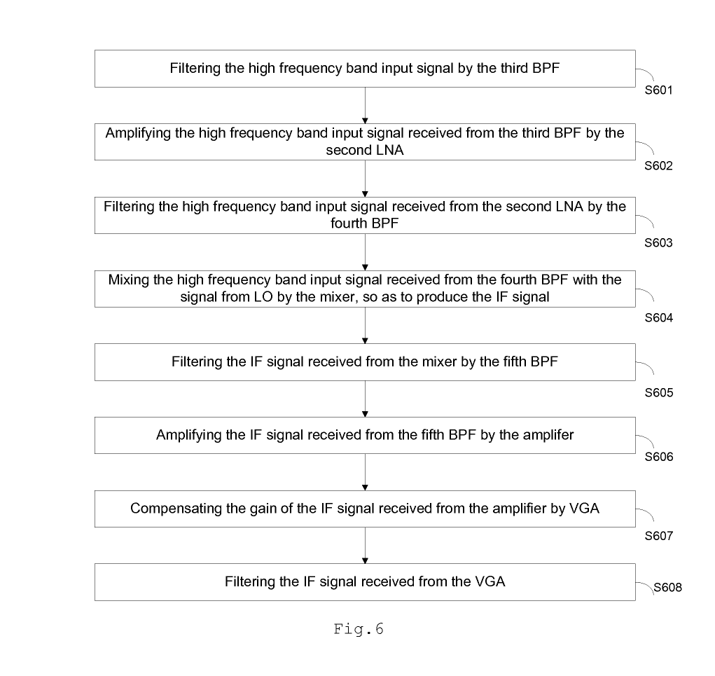

FIG. 6 illustrates a flowchart showing a processing method performed by at least one down conversion module according to an exemplary embodiment of present invention. As illustrated in FIG. 6, in step S601, the high frequency band input signal is received and filtered by the third BPF 304. In step S602, the high frequency band input signal received from the third BPF 304 is amplified by the second LNA 305. In step S603, the high frequency band input signal received from the second LNA 305 is filtered by a fourth BPF 306. In step S604, the high band input signal received from the fourth BPF 306 is mixed with the signal from the local oscillator (LO) by the mixer 307, so as to produce intermediate frequency (IF) signal. In step 605, the IF signal received from the mixer 307 is filtered by the fifth BPF 308. In step S606, the IF signal received from the fifth BPF 308 is amplified by the amplifier 309. In step S607, the gain of the IF signal received from the amplifier 309 is compensated by the variable gain amplifier (VGA) 310. Further in step S608, the IF signal received from the VGA 310 is filtered by the sixth BPF 311, so as to avoid alias and avoid impacting the low frequency band input signal received from the direct sampling module.

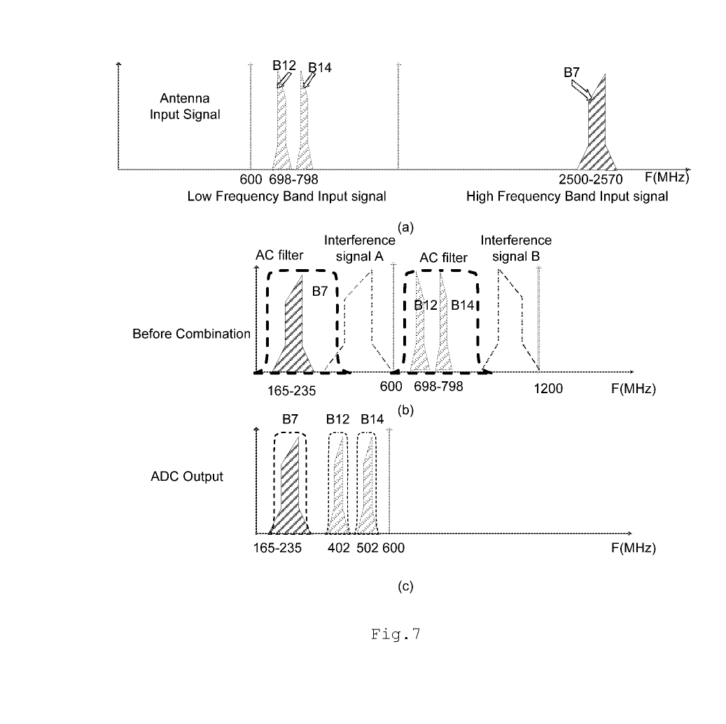

FIG. 7 illustrates signal characteristic analysis of multi-band receiver according to an exemplary embodiment of present invention. Here, an example of the multi-band receiver is the receiver in Base Station (BS), and the input signal includes two low frequency band input signal and one high frequency band signal. Assuming ADC sample speed is 1.2 GHz, and the high frequency band input signal is B7, and the two low frequency band input signals are B12 and B14, respectively. The below table 1 shows the uplink BS and downlink BS receiving frequencies of the three signals.

TABLE 1

| | Uplink BS | | Downlink BS | |
|---|---|---|---|---|
| | receiving frequency | | transmitting frequency | |
| Band | F_{UL low}[MHz] | F_{UL high}[MHz] | F_{DL low}[MHz] | F_{DL high}[MHz] |
| B12 | 698 | 716 | 728 | 746 |
| B14 | 788 | 798 | 758 | 768 |
| B7 | 2500 | 2570 | 2620 | 2690 |

FIG. 7(a) illustrates the signal characteristic of the two low frequency band input signals B12, B14 and one high frequency band input signal B7 from the antenna. The two low frequency band input signal are received and processed by the direct sampling module, and the high frequency band input signal are received and processed by the down conversion module.

FIG. 7(b) illustrates the signal characteristics before the combination step by the combiner. The frequency band of the signals B12 and B14 is not changed, and the frequency band of the signal B7 is down converted to 165235 MHz. As shown in FIG. 7, Nyquist zone 1 is located below 600 MHz, and Nyquist zone 2 is located between 600 MHz to 1200 MHz. There might be interference signal A and B located in Nyquist zone 1 and Nyquist zone 2, and accordingly there might be the alias of the interference signal A located in Nyquist zone 2 and the alias of the interference signal located in Nyquist zone 1.

In order to correctly filter signal B7 in Nyquist zone 1, the alias of the interference signal B should be avoided, and similarly, in order to correctly filter signals B12 and B14 in Nyquist zone 2, the alias of the interference signal A should be avoided. Also, there is a need to avoid the signals output from the direct sampling module and the down conversion module impacting each other. Therefore, the special filters are needed in both of the direct sampling module and the down conversion module, and the shape of which is shown in FIG. 7(b) (AC filters shown in FIG. 7(b)). This filter can correctly filter the wanted signal by avoiding the alias of the interference signals and avoiding signals from the direct sampling module and the down conversion module impacting each other. Since there are enough transition frequency bands for the special filter, it is quite easy to implement this filter. FIG. 7(c) illustrates the signal characteristics from the ADC output.

It can be seen from the above, the multi-band receiver according to the embodiments of the present invention can be easily implemented and can cover relatively wide frequency band input signal. Also, by involving the direct sampling module in the multi-band receiver, it can significantly reduce the cost, and reduce the size of the receiver.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A multi-band receiver for receiving and processing different frequency band signals, comprising:
a direct sampling module, for receiving and processing a low frequency band input signal from a first antenna;
at least one single down conversion module, for receiving and processing a high frequency band input signal from a second antenna;
a combiner coupled to said direct sampling module and said at least one single down conversion module, for combining said low frequency band input signal received from said direct sampling module and said high frequency band input signal received from said at least one single down conversion module;
an Analog Digital Converter (ADC) coupled to said combiner, for converting analog signal received from said combiner into digital signal.

2. The receiver of claim 1, wherein said direct sampling module comprises:
a first band pass filter (BPF), for filtering said low frequency band input signal received from said first antenna;
a first low noise amplifier (LNA) coupled to said first BPF, for amplifying said low frequency band input signal received from said first BPF;
a second BPF coupled to said first LNA, for filtering said low frequency band input signal received from said first LNA, so as to avoid alias and avoid impacting said high frequency band input signal received from said at least one single down conversion module.

3. The receiver of claim 1, wherein said at least one single down conversion module comprises:
a third BPF, for filtering said high frequency band input signal received from said second antenna;
a second LNA coupled to said third BPF, for amplifying said high frequency band input signal received from said third BPF;
a fourth BPF coupled to said second LNA, for filtering said high frequency band input signal received from said second LNA;
a mixer coupled to said fourth BPF, for mixing said high frequency band input signal received from said fourth BPF with signal from the local oscillator (LO), so as to produce intermediate frequency (IF) signal;
a fifth BPF coupled to said mixer, for filtering said IF signal received from said mixer;
an amplifier coupled to said fifth BPF, for amplifying said IF signal received from said fifth BPF;
an variable gain amplifier (VGA) coupled to said amplifier, for compensating gain of said IF signal received from said amplifier;
a sixth BPF coupled to said VGA, for filtering said IF signal received from said VGA, so as to avoid alias and avoid impacting said low frequency band input signal received from said direct sampling module.

4. The receiver according to claim 1, wherein said first antenna and said second antenna are the same and one antenna from which both said low frequency input signal and said high frequency signal are received.

5. The receiver of claim 3, wherein said fourth BPF and said fifth BPF are the same and one BPF shared by said direct sampling module and said at least one down conversion module.

6. The receiver according to claim 3, wherein said first LNA and said second LAN are the same and one LNA shared by said direct sampling module and said at least one down conversion module.

7. The receiver of claim 3, wherein said fourth filter or said fifth filter is Surface Acoustic Wave (SAW) filter.

8. The receiver according to claim 1, wherein said low frequency band frequency input signal denotes the input signal capable of being directly sampled by said direct sampling module.

9. The receiver according to claim 1, wherein said low frequency band input signal is the input signal with frequency band below or equal to 1 GHz.

10. The receiver according to claim 1, wherein said high frequency band frequency input signal denotes the input signal not capable of being directly sampled, and to be down converted by said at least one down conversion module.

11. The receiver according to claim 1, wherein said high frequency band input signal is the input signal with frequency band above 1 GHz.

12. A device comprising at least one multi-band receiver according to claim 1.

13. A method for receiving and processing different frequency band signals, comprising:
receiving and processing low frequency band input signal by direct sampling module;
receiving and processing high frequency band input signal by at least one down conversion module;
combining said low frequency band input signal received from said direct sampling module and said high frequency band input signal received from said at least one down conversion module by combiner;
converting analog signal received from said combiner into digital signal by an Analog Digital Converter (ADC).

14. The method of claim 13, wherein the step (a) further comprises:
filtering said low frequency band input signal by a first band pass filter (BPF);
amplifying said low frequency band input signal received from said first BPF by a first low noise amplifier (LNA);
filtering said low frequency band input signal received from said first LNA by a second BPF, so as to avoid alias and avoid impacting said high frequency band input signal received from said at least one single down conversion module.

15. The method of claim 13, wherein the step (b) further comprises:
filtering said high frequency band input signal by a third BPF;
amplifying said high frequency band input signal received from said third BPF by a second LNA;
filtering said high frequency band input signal received from said second LNA by a fourth BPF;
mixing said high frequency band input signal received from said fourth BPF with signal from the local oscillator (LO) by a mixer, so as to produce intermediate frequency (IF) signal;
filtering said IF signal received from said mixer by a fifth BPF;
amplifying said IF signal received from said fifth BPF by an amplifier;
compensating gain of said IF signal received from said amplifier by an variable gain amplifier (VGA);
filtering said IF signal received from said VGA by a sixth BPF, so as to avoid alias and avoid impacting said low frequency band input signal received from said direct sampling module.
